(19) United States
(12) Patent Application Publication
(10) Pub. No.: US 2025/0305894 A1
(43) Pub. Date: Oct. 2, 2025

(54) METHOD AND SYSTEM FOR DETECTING BOLT LOOSENING

(71) Applicants: Shanghai JiaoTong University, Shanghai (CN); Murata Manufacturing Co., Ltd., Nagaokakyo-shi (JP)

(72) Inventors: Yanfeng SHEN, Shanghai (CN); Runye LU, Shanghai (CN); Shulong ZHOU, Shanghai (CN); Xuezhi PENG, Shanghai (CN); Shenjing HE, Shanghai (CN)

(21) Appl. No.: 19/089,216

(22) Filed: Mar. 25, 2025

(30) Foreign Application Priority Data
Mar. 29, 2024 (CN) 202410381352.X

(51) Int. Cl. G01L 1/16; G01L 5/00

(52) U.S. Cl. CPC G01L 1/16; G01L 5/00

(57) ABSTRACT

A method includes applying an excitation signal to a piezoelectric sensor on a bolted connection structure, detecting a signal delivered through a bolt, calculating, from a detected signal, a characteristic value of the signal delivered through the bolt, performing temperature compensation processing on the characteristic value based on an operating ambient temperature of the bolt, and detecting whether the bolt loosens based on the characteristic value on which the temperature compensation processing has been performed.

### CROSS REFERENCE TO RELATED APPLICATIONS

This application claims the benefit of priority to Chinese Patent Application No. 202410381352.X filed on Mar. 29, 2024. The entire contents of this application are hereby incorporated herein by reference.

### BACKGROUND OF THE INVENTION

### 1. Field of the Invention

The present disclosure relates to the technical field of bolt loosening detection, in particular to methods and systems for detecting bolt loosening.

### 2. Description of the Related Art

Due to low cost and low construction difficulty, bolted structures, as the main type of detachable connection, have been widely used in many industrial fields, such as mechanical engineering, civil industry, and aerospace engineering. For safety reasons, bolted connections must strict meet standards of durability, reliability, and integrity. However, in practice, bolt loosening often occurs due to improper installation, dynamic loading, corrosion, and the like, which is a serious threat to the safety of engineering infrastructures. Therefore, continuous monitoring and accurate detection of bolt loosening is essential to ensure structural safety.

Conventional detection methods require a lot of manpower, material resources, and complex processes, resulting in high maintenance costs. In contrast, real-time health monitoring eliminates the need for regular manual maintenance and complex sampling processes. Existing ways to monitor bolt loosening include, but are not limited to, an electromechanical impedance method, an acoustic emission method, an acoustic vibration sensing method, and linear and nonlinear ultrasonic methods. For example, the linear and non-linear ultrasonic methods may be used to monitor and determine the degree of bolt loosening.

However, the prior art normally can only effectively monitor the loosening of bolts at normal temperature, but cannot evaluate the influence of ambient temperature variations on the structure itself and the propagation of ultrasonic guided wave signals within the structure, which leads to a reduction in the monitoring accuracy and a misjudgment of the degree of loosening and thus causes great difficulty to practical industrial application.

### SUMMARY OF THE INVENTION

In view of the above, example embodiments of the present invention provide methods and systems for detecting bolt loosening, so as to improve the accuracy of detecting bolt loosening and to avoid misjudgment of bolt loosening.

According to an example embodiment of the present invention, a method for detecting bolt loosening includes applying an excitation signal to a piezoelectric sensor provided on a bolted connection structure, detecting a signal delivered through a bolt, calculating, from a detected signal, a characteristic value of the signal delivered through the bolt, performing temperature compensation processing on the characteristic value based on an operating ambient temperature of the bolt, and detecting whether the bolt loosens based on the characteristic value on which the temperature compensation processing has been performed.

According to another example embodiment of the present invention, a system for detecting bolt loosening includes a function generator to generate an excitation signal, a piezoelectric sensor on a bolted connection structure, and being connected to the function generator and including the excitation signal as an input signal, and a processor connected to the piezoelectric sensor and to calculate, based on a signal delivered through a bolt detected by the piezoelectric sensor, a characteristic value of the signal delivered through the bolt, to perform temperature compensation processing on the characteristic value based on an operating ambient temperature of the bolt, and to detect whether the bolt loosens based on the characteristic value on which the temperature compensation processing has been performed.

According to the methods and systems for detecting bolt loosening provided by example embodiments of the present invention, temperature compensation processing is performed on a characteristic value calculated from a signal delivered through a bolt based on an operating ambient temperature of the bolt to eliminate an influence of the operating ambient temperature on the characteristic value. Since the characteristic value (e.g. the transmitted energy of the wave delivered through the bolt) is influenced not only by the bolt loosening but also by the variations in the operating ambient temperature of the bolt, after the characteristic value is calculated, the influence of temperature variation on the characteristic value is eliminated by performing the temperature compensation processing on the characteristic value, thus, the characteristic value from which the influence of temperature variation is eliminated may be obtained, and the detection of bolt loosening based on such characteristic value is more accurate. Therefore, the accuracy of detecting bolt loosening may be improved and the misjudgment of bolt loosening may be avoided, which is more conducive to the practical industrial application of bolts.

The above and other elements, features, steps, characteristics and advantages of the present invention will become more apparent from the following detailed description of the example embodiments with reference to the attached drawings.

### BRIEF DESCRIPTION OF THE DRAWINGS

The drawings, which are incorporated in and provide a portion of the present description, together with the description, illustrate example embodiments, features, and advantageous effects of the present invention, and explain the principles of example embodiments of the present invention.

FIG. 1 is a flowchart of a method of detecting bolt loosening according to an example embodiment of the present invention.

FIG. 2A is a schematic diagram of a portion of a system for detecting bolt loosening.

FIG. 2B is a schematic diagram of a contact pair within the bolted structure.

FIGS. 3A to 3D are stress nephograms of a bolt under static loading according to an example embodiment of the present invention.

FIG. 4 is a schematic diagram of deformation of bolt contact surfaces at different temperatures under application of excitation according to an example embodiment of the present invention.

FIG. 5 is a flowchart of performing temperature compensation processing according to an example embodiment of the present invention.

FIG. 6 is a flowchart of performing temperature compensation processing according to an example embodiment of the present invention.

FIGS. 7A to 7C shows a simulation result of pulsed excitation at different temperatures according to an example embodiment of the present invention.

FIGS. 8A to 8C shows a simulation result of mixed frequency excitation under different preloads according to an example embodiment of the present invention.

FIGS. 9A to 9C show an experimental result of pulsed excitation at different temperatures according to an example embodiment of the present invention.

FIG. 10A is a comparison diagram of the variation of transmitted energy with temperature variation at different torques according to an example embodiment of the present invention.

FIG. 10B shows a fitted surface of the variation of transmitted energy with torque variation and temperature variation according to an example embodiment of the present invention.

FIGS. 11A and 11B show an experimental result of pulsed excitation at different temperatures according to an example embodiment of the present invention.

FIG. 12A is a comparison diagram of the variation of nonlinearity with temperature variation at different torques according to an example embodiment of the present invention.

FIG. 12B shows a fitted surface of the variation of nonlinearity with torque variation and temperature variation according to an example embodiment of the present invention.

FIG. 13 is a block diagram of a system for detecting bolt loosening according to an example embodiment of the present invention.

### DETAILED DESCRIPTION OF THE EXAMPLE EMBODIMENTS

Various example embodiments, features and advantageous effects of the present invention will be described in detail below with reference to the drawings. In the drawings, the same or corresponding reference signs denote elements with the same or similar functions. Although various features of the example embodiments are shown in the drawings, unless otherwise specified, the drawings are not necessarily drawn to scale.

The word “exemplary” used here means “providing an example, example embodiment or illustration”. Any example embodiment described here as “exemplary” is not necessarily to be interpreted as superior to or better than other example embodiments.

In addition, to better explain the present invention, numerous details are provided in the following example embodiments. It is appreciated by those skilled in the art that the present invention can still be implemented without some specific details. In some example embodiments, methods, devices, elements and circuits well known to those skilled in the art are not described in detail in order to highlight the gist of the present invention.

As mentioned above, the prior art normally can only effectively monitor the loosening of bolts at normal temperature, but cannot evaluate the influence of ambient temperature variation on the structure itself and the propagation of ultrasonic guided wave signals within the structure, which leads to a reduction in the monitoring accuracy and a misjudgment of the degree of loosening and thus causes great difficulty to practical industrial application.

In view of the above, example embodiments of the present invention recognize that the output signal of the piezoelectric sensor is affected not only by the loosening of the bolt, but also by variations in the operating ambient temperature of the bolt, and that if the influence of the temperature is not taken into account, the influence of the temperature on the output signal will be confused with the influence of the bolt loosening on the output signal, which may lead to a reduction in the accuracy of detecting bolt loosening and a misjudgment of bolt loosening. On this basis, example embodiments of the present invention discloses that the influence of the temperature on the output signal may be eliminated by performing temperature compensation processing to obtain a signal from which the influence of temperature variation is eliminated, and the detection of bolt loosening based on such signal will be more accurate. Therefore, if the temperature compensation processing is performed on the characteristic value calculated from the signal delivered through the bolt, the influence of the operating ambient temperature on the characteristic value may be eliminated and the detection of bolt loosening based on the characteristic value from which the influence of temperature variation is eliminated will be more accurate, thus improving the accuracy of detecting bolt loosening and avoiding the misjudgment of bolt loosening.

Therefore, compared with the prior art which can only monitor the loosening of bolts at normal temperature but cannot cope with the complex temperature environment in which the bolted structure is located, example embodiments of the present invention perform the temperature compensation on processing the characteristic value calculated from the signal delivered through the bolt based on the operating ambient temperature of the bolt to eliminate the influence of the operating ambient temperature on the characteristic value. By performing the temperature compensation processing on the calculated characteristic value, the influence of temperature variations on the characteristic value may be eliminated, so that the characteristic value from which the influence of temperature variation is eliminated may be obtained, and the detection of bolt loosening based on such characteristic value is more accurate. Thus, the accuracy of detecting bolt loosening may be improved and the misjudgment of bolt loosening may be avoided.

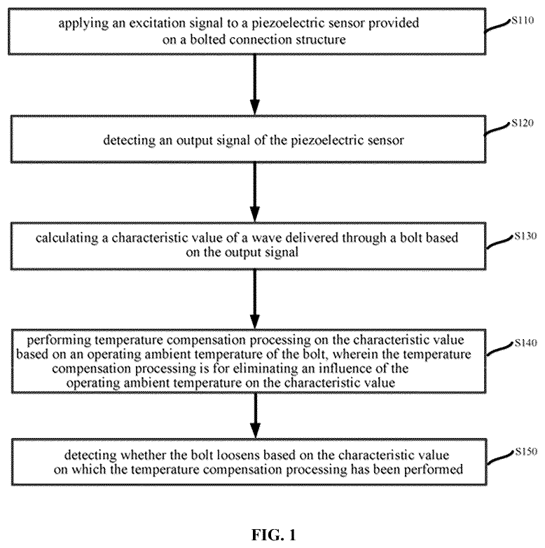

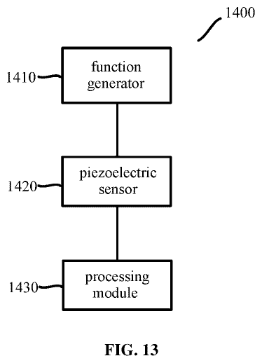

Based on the above concept, a method and a system for detecting bolt loosening as shown in FIGS. 1 and 13 are proposed.

FIG. 1 is a flowchart of a method for detecting bolt loosening according to an example embodiment of the present invention. Referring to FIG. 1, the detection method may include the following steps.

In step S110, an excitation signal is applied to a piezoelectric sensor provided on a bolted connection structure.

In this example embodiment, the bolted connection structure may be connected by a bolt. In order to detect whether the bolt loosens, a piezoelectric sensor may be provided on the bolted connection structure, and an excitation signal may be applied to the piezoelectric sensor. In one possible example of a method, the piezoelectric sensor is, for example, a piezoelectric wafer active sensor (PWAS), and the excitation signal may include, for example, a low-frequency pumping wave, a high-frequency detection wave, etc.

In one possible example of a method, the excitation signal may be generated by a signal generator, for example KEYSIGHT 33500B, and the generated excitation signal may be applied directly to the PWAS provided on the bolted connection structure, or the generated excitation signal may be subjected to corresponding signal processing and the processed signal may then be applied to the PWAS provided on the bolted connection structure. For example, the generated excitation signal may be amplified by a power amplifier, and the amplified signal may then be applied to the T-PWAS provided on the bolted connection structure.

After the excitation signal is applied to the piezoelectric sensor, the following step S120 may be performed.

In step S120, a signal delivered through a bolt is detected.

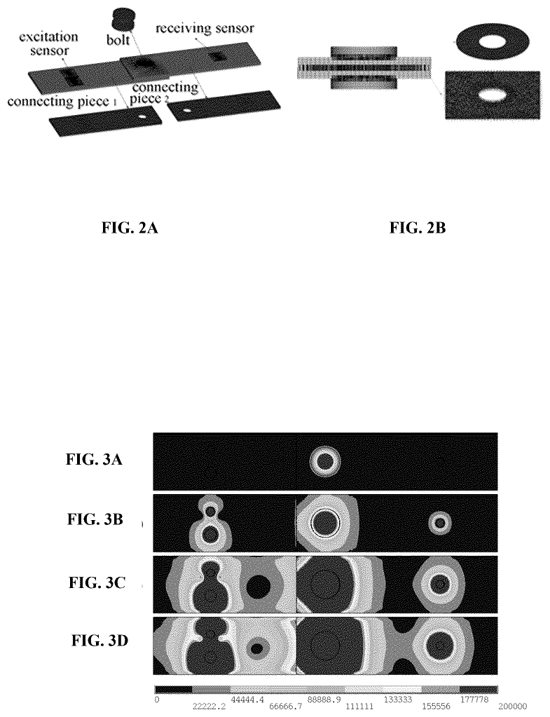

In this example embodiment, due to the piezoelectric effect, the electric excitation will be converted into mechanical vibration and propagated in the bolt in the form of an ultrasonic guided wave. Therefore, a signal delivered through the bolt may be detected by, for example, a piezoelectric sensor. Referring to FIGS. 2A and 2B, a signal delivered through the bolt may be received by an R-PWAS, that is, the signal received by the R-PWAS is the signal delivered through the bolt. In one possible example of a method, the signal received by the R-PWAS may be recorded by, for example, an oscilloscope, such as KEYSIGHT DSO-X 3014 T.

In step S130, a characteristic value of the signal delivered through the bolt is calculated from the detected signal.

In this example embodiment, after the signal delivered through the bolt is detected, the characteristic value of the signal delivered through the bolt may be calculated from the signal delivered through the bolt using a suitable method in the prior art.

In one possible example of a method, the step S130 may include performing a frequency domain transformation on the detected signal to convert a voltage signal in a time domain into a voltage signal in a frequency domain, and calculating transmitted energy for bolt loosening detection based on the voltage signal in the frequency domain, the transmitted energy representing energy carried by the signal delivered through the bolt, wherein the characteristic value comprises the transmitted energy.

In this example embodiment, a signal (e.g., a voltage signal in the time domain) received by the R-PWAS may be converted into a voltage signal in the frequency domain, and the voltage signal in the frequency domain is integrated to calculate the transmitted energy. By way of example, transmitted energy E may be calculated using the formula

$$E = \int ( {A}_{Re}^{2} + {A}_{Im}^{2} ) df ,$$

where A_{RE} and A_{Im} represent a real part and an imaginary part of the voltage signal in the frequency domain, respectively, and f represents a frequency corresponding to the voltage signal in the frequency domain.

In one possible example of a method, the greater the contact area between the bolt and the bolted connection structure, the greater the transmitted energy.

In this example embodiment, a rough contact surface may be simulated by adjusting a distance between a contact pair. By way of example, to simulate a rough contact surface, two sets of random numbers are generated and added to the Z-direction coordinates of the contact nodes between two aluminum plates. By applying different excitation signals to the PWAS provided on a connecting piece 1 and adjusting the distance between the contact pair, it may be concluded from observing the transmitted energy that the transmitted energy increases as the actual contact area increases, that is, there is a positive correlation between the transmitted energy and the actual contact area.

In one possible example of a method, the step S130 may include obtaining a sideband response of the detected signal, and calculating a nonlinear index for bolt loosening detection based on the sideband response and an amplitude of a frequency of the excitation signal, wherein the characteristic value includes the nonlinear index.

In this example embodiment, after the signal delivered through the bolt is detected, the sideband response and the amplitude of the frequency of the signal may be obtained, and the non-linear index β may be calculated using the formula

$$β = \frac{( {A}_{L} + {A}_{R} )}{2} - {A}_{LF} - {A}_{H F} ,$$

where A_{L} and A_{R} represent an amplitude of a left sideband and an amplitude of a right sideband, respectively, and A_{LF} and A_{HF} represent an amplitude (in dB) of a low (pumping) frequency and an amplitude (in dB) of a high (detecting) frequency, respectively.

In step S140, the temperature compensation processing is performed on the characteristic value based on the operating ambient temperature of the bolt, wherein the temperature compensation processing is to eliminate the influence of the operating ambient temperature on the characteristic value.

In this example embodiment, temperature variation influences the characteristic value. Through research, it has been discovered that the time domain response does not change much with the rise of temperature, but the dominant frequency response in the frequency domain decreases with the rise of temperature and the sideband response increases with the rise of temperature, which leads to the improvement of the nonlinear index B. To verify the findings, a finite element analytical model is constructed in this example embodiment.

Referring to FIGS. 2A and 2B, two aluminum perforated plates define and function as the two portions being connected by a bolt, connecting pieces 1 and 2 define a bolted connection structure, and a cylindrical steel block simulates the bolt, with a thin cylinder in the middle of the steel block representing a threaded post, and two thick cylinders representing a screw head and a nut, respectively. In one possible example of a method, the two aluminum plates have the same or substantially the same dimensions (for example, a length of about 175 mm, a width of about 50 mm, and a thickness of about 4 mm), the overlapping portions provide a square with a side length of about 50 mm, a circular hole is located in the center or approximate center of the square, and the diameter of the hole is about 15 mm, for example. The screw head and the nut of the bolt have, for example, a thickness of about 4 mm and a diameter of about 25 mm. A distance between an inner surface of the screw head and an inner surface of the nut is, for example, about 8 mm, which is equal or substantially equal to the sum of the thicknesses of the two aluminum plates. The threaded post has, for example, a diameter of about 9 mm.

The three piezoelectric sensors are piezoelectric wafer active sensors (PWAS), two of which are provided on the connecting piece 1 and the third of which is provided on the connecting piece 2. One PWAS provided on the connecting piece 1 is configured to transmit low-frequency pumping waves and has, for example, a diameter of about 5 mm and a thickness of about 0.5 mm. The other PWAS provided on the connecting piece 1 is configured to transmit high-frequency detection waves (T-PWAS) and has, for example, a diameter of about 3.5 mm and a thickness of about 0.2 mm. The PWAS provided on the connecting piece 2 corresponds to the receiving sensor in FIG. 2A for receiving the signal (wave) delivered through the bolt, and has the same or substantially the same dimensions as the high-frequency excitation PWAS (R-PWAS). Referring to FIG. 2B, three contact pairs are introduced in this example embodiment, which are located between the screw head and the upper plate, between the two plates, and between the lower plate and the nut, respectively. The bolt preload is represented by an axial pressure load applied to the outer surfaces of the screw head and nut. The increase in ambient temperature is simulated by a uniform temperature applied to all nodes of the model. Simulations are carried out at six different temperatures, i.e., about 0° C. (no temperature variation), about 2° C., about 4° C., about 6° C., about 8° C., and about 10° C., at a torque of about 1 Nm.

After completion of static loading, the stress nephogram of the bolt is shown in FIGS. 3A to 3D. FIG. 3A is a stress nephogram without temperature variation, and FIGS. 3B to 3D are stress nephograms with a temperature rise by about 2° C., by about 6° C., and by about 10° C., for example, respectively. Referring to FIG. 3A, when no thermal load is introduced, the stress exists only around the bolt. Referring to FIGS. 3B to 3D, the stress at the bolted connection increases significantly as the temperature rises. Therefore, the introduction of thermal loads leads to a significant increase in the stress at the bolted connection and induces stress between the PWASs and the aluminum plates, and the induced stress is generated from the thermal expansion of the material. After static loading, a 5-period pulse signal is applied to the smaller T-PWAS to observe the change in the transmitted energy of the signal, and a low-frequency sine wave (pumping wave) is applied to the larger T-PWAS and a high-frequency sine wave (detection wave) having the same wavelength and amplitude is applied to the smaller T-PWAS to observe the change in the sideband response of the signal.

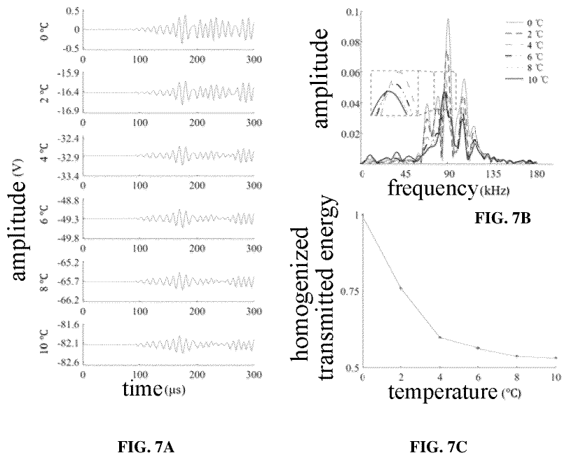

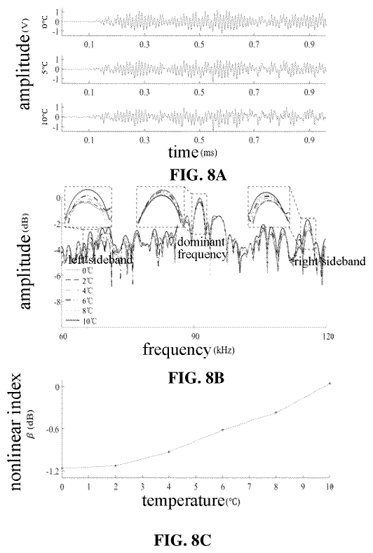

Referring to FIGS. 7A to 7C, the simulation results obtained by applying pulsed excitation at different temperatures include the variation trends of the original time domain, frequency domain response, and transmitted energy of the received signal. FIGS. 7A to 7C are the variation trend diagrams of the amplitude of the time domain signal, amplitude of the frequency domain signal, and transmitted energy, respectively, and all of the three responses decrease with the rise of temperature. Referring to FIGS. 8A to 8C, the simulation results obtained by applying mixed frequency excitation under different preloads and at different temperatures include the variations trends of the original time domain, frequency domain response, and transmitted energy of the received signal. FIGS. 8A to 8C are the variation trend diagrams of the amplitude of the time domain signal, amplitude of the frequency domain signal, and nonlinear index B, respectively, wherein the time domain response does not change much, but the dominant frequency response in the frequency domain decreases with the rise of temperature and the sideband response increases with the rise of temperature, which leads to the enhancement of the nonlinear index B. This phenomenon may be explained by the disengagement of the contact surfaces caused by the rise of temperature. Referring to FIG. 4, due to the limitation of the bolt size, the thermal expansion generated at the bolted connection may only spread laterally, causing outward detachment and warping of the structure under axial stress. The range and amplitude of the detachment gradually increase with the rise of temperature. The energy generated by a wave propagating through the bolt is proportional to the actual contact area. Therefore, the disengagement of the contact surfaces leads to a decrease in the transmitted energy and a weakening of the dominant frequency response. The generation of the sideband depends on the “breathing” motion of the contact surfaces. In order to create this periodic opening and closing motion, a certain amount of space is required between the contact surfaces. The disengagement of the contact surfaces provides such a space and therefore the nonlinear index β is improved.

To further verify the above findings of the finite element model, experimental verification is performed.

The experimental verification equipment may be arranged. The structure to be tested includes two aluminum plates connected by a bolt, one large PWAS (for transmitting low-frequency pumping waves) and one small PWAS (for transmitting high-frequency detection waves) are mounted on the lower plate, and one PWAS (for receiving signals) is mounted on the upper plate. Both ends of each plate are padded with foam to simulate free boundaries. The dimensions and materials of all components are the same or substantially the same as those of the finite element model.

The experiment is performed using the pitch-catch technique. The excitation signal is generated by the KEYSIGHT 33500B signal generator and amplified by a power amplifier to actuate the T-PWAS. Due to the piezoelectric effect, the electric excitation will be converted into mechanical vibration and propagated in the structure in the form of an ultrasonic guided wave. The signal received by the R-PWAS is recorded by the KEYSIGHT DSO-X 3014 T oscilloscope. The torque of the bolt is adjusted and recorded by a torque wrench. The ambient temperature is regulated by an oven and monitored by a thermocouple fixed near the bolted connection. The thermocouple signal is converted into an electrical signal by a temperature sensor, and then collected by the Altai USB2871-D data acquisition apparatus. The PWAS is covered and protected by a flexible printed circuit, and the input and output of signals are realized through shielded wires. The dimensions of the respective structures and the parameters of the excitation signal are consistent with those in the simulation of the finite element model. The verification experiment was performed in an oven.

Prior to conducting the experiment, the torque of the bolt is adjusted to, for example, about 10 Nm at room temperature (for example, about 25° C.) and the bolt is put into the oven. The temperature in the oven gradually rises to about 75° C. In this process, one sample is taken at approximately every 10° C., with a total of six samples at different temperatures to form a temperature rise curve. The oven is then turned off and the temperature naturally declines to room temperature. During this process, one sample is taken at approximately every 10° C. to form a temperature declining curve. Five sets of variable-temperature repeated experiment are performed, while ensuring that other conditions remain unchanged. Subsequently, the torque of the bolt is adjusted to, for example, about 20 Nm, about 30 Nm, and about 40 Nm at room temperature, and the above process is repeated.

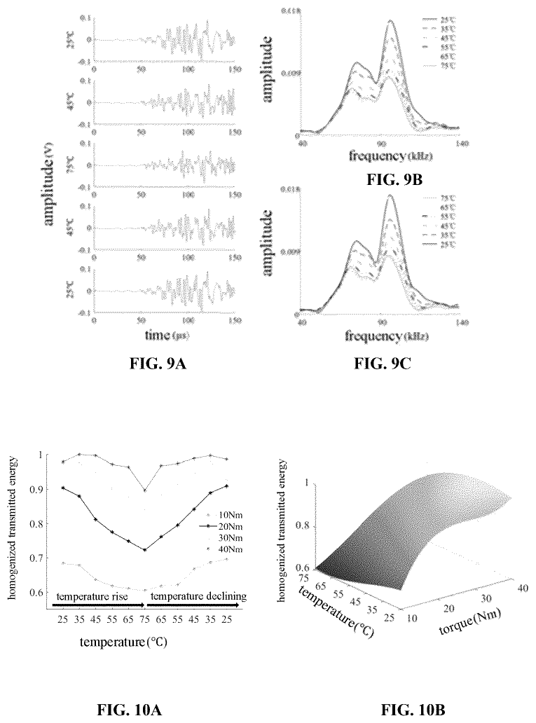

To show the variation trend of the transmitted energy with the temperature variation and its consistency during temperature rise and temperature declining, FIGS. 9A to 9C show five sets of time domain signals and frequency domain signals at a torque of about 20 Nm at different temperatures. FIGS. 9A to 9C respectively show the time domain signal in the processes of temperature rise and temperature declining, the frequency domain signal in the process of temperature rise, and the frequency domain signal in the process of temperature declining. The signal acquisition environment from top to bottom is, for example, room temperature (about 25° C.) before temperature rise, temperature rise to about 45° C., temperature rise to about 75° C. (peak temperature), temperature declining to about 45° C., and temperature declining to room temperature (about 25° C.), respectively. In the process of temperature rise, the amplitude and dominant frequency response of the signal tend to decrease, but gradually increase in the process of temperature declining. In the process of temperature declining, when the temperature lowers to a certain temperature, the received signal tends to be consistent with that when the temperature rises to the corresponding stage, which proves that the structural response is only related to the current temperature and not to the process undergone to reach to this temperature.

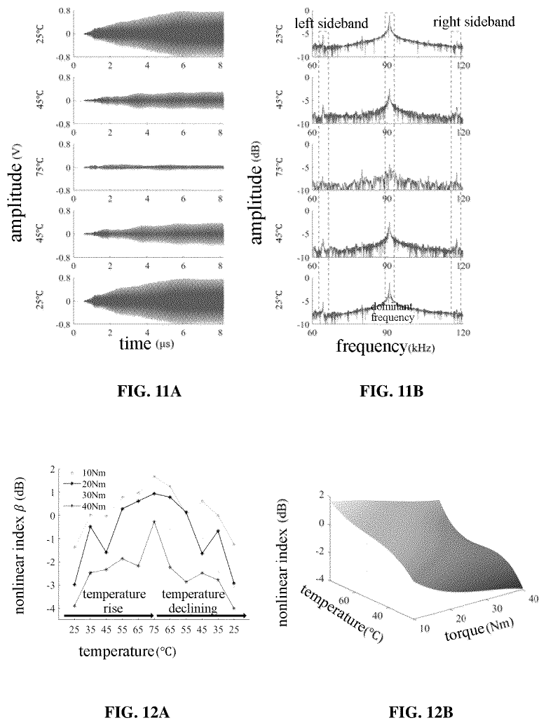

The transmitted energy at four different fastening levels of, for example, about 10 Nm, about 20 Nm, about 30 Nm, and about 40 Nm is homogenized to obtain FIG. 10A. At each temperature, the transmitted energy decreases with the decrease of torque, and the degree of the decrease gradually increases, which is consistent with the experimental results of the preload variation. In order to characterize the transmitted energy over the full loosening period and temperature range, a cubic term interpolation fit is applied to the discrete data to obtain FIG. 10B. In the fitted surface, the transmitted energy increases with the decrease of temperature and the increase of torque.

To explore the changes of structural resonance and nonlinear response with temperature variation, FIGS. 11A and 11B show five sets of signals at different temperatures and their spectra with the same or substantially the same transmitted energy, wherein FIGS. 11A and 11B show the time domain signals and the frequency domain signals, respectively. In the process of temperature rise, the amplitude of structural resonance significantly decreases, while in the process of temperature declining, the amplitude increases back to the corresponding level. This phenomenon again shows that the structural resonance response is only related to the current ambient temperature and not to the process of progressing to this temperature. FIG. 12A shows the variation of the nonlinear index at four different fastening levels, in which the nonlinear index increases with the temperature rise and decreases with the temperature declining at all bolt fastening levels. Similar to the case of the transmitted energy, an interpolated fit to the nonlinear index yields a fitted surface of the full fastening level and the temperature range in FIG. 12B. In the fitted surface, the nonlinearity is improved with the rise of temperature and the decrease of torque, which is opposite to the change in the transmitted energy. The combination of the two fitted surfaces enables a more comprehensive and accurate assessment of bolt loosening at different temperatures.

Therefore, through the dual verification of finite element simulation and experimental verification, it has been discovered that temperature affects the characteristic value, and how to perform the temperature compensation processing on the characteristic value may be determined based on the variation trend of the characteristic value with temperature variation. By way of example, if the temperature variation leads to an increase in the characteristic value, the temperature compensation processing for eliminating the increase in the characteristic value caused by the temperature variation may be performed, and conversely, if the temperature variation leads to a decrease in the characteristic value, the temperature compensation processing for eliminating the decrease in the characteristic value caused by the temperature variation may be performed, thus eliminating the influence of the operating ambient temperature on the characteristic value.

In step S150, whether the bolt loosens is detected based on the characteristic value on which the temperature compensation processing has been performed.

In this example embodiment, since the temperature compensation processing is performed on the characteristic value, the influence of the temperature on the characteristic value is eliminated. Thus, whether the bolt loosens may be detected more accurately based on the processed characteristic value. A suitable method in the prior art may be used to detect whether the bolt loosens based on the characteristic value.

In one possible example of a method, the detected signal(s) corresponding to the first excitation or the first several excitations may be used as the reference signal. The first acquisition establishes the characteristic value of the bolt in the absence of loosening. Detection is then performed in a predetermined period (e.g. every day), and the detected signal is compared with the reference signal, e.g. by characteristic value (which may include the transmitted energy and the sideband response) comparison. If a difference between the characteristic values exceeds a threshold, it is determined that bolt loosening has occurred. Otherwise, it is determined that no bolt loosening occurs.

According to the methods and systems for detecting bolt loosening provided by example embodiments of the present invention, temperature compensation processing is performed on a characteristic value calculated from a signal delivered through a bolt based on an operating ambient temperature of the bolt, in order to eliminate the influence of the operating ambient temperature on the characteristic value. Since the characteristic value (e.g. the transmitted energy of the wave delivered through the bolt) is influenced not only by the bolt loosening but also by the variations in the operating ambient temperature of the bolt, after the characteristic value is calculated, the influence of temperature variation on the characteristic value is eliminated by performing the temperature compensation processing on the characteristic value, thus the characteristic value from which the influence of temperature variation is eliminated may be obtained, and the detection of bolt loosening based on such characteristic value is more accurate. Accordingly, the accuracy of detecting bolt loosening may be improved and the misjudgment of bolt loosening may be avoided, which is more conducive to the practical industrial application of bolts.

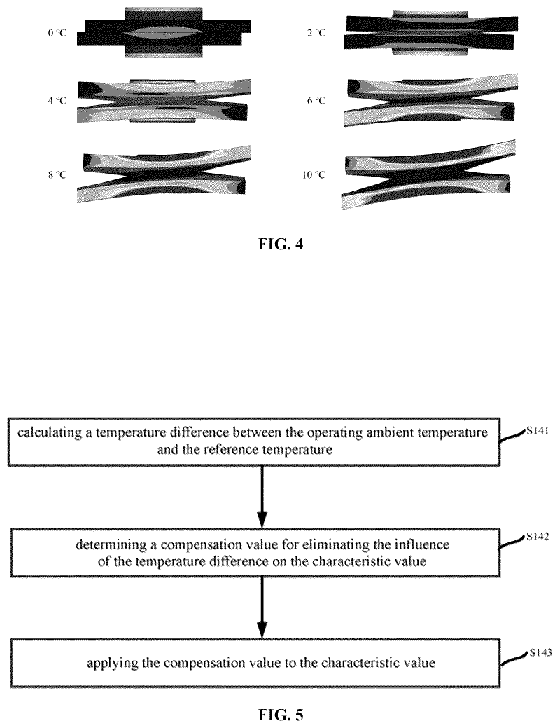

In one possible example of a method, as shown in FIG. 5, the step S140 may include a step S141 of calculating a temperature difference between the operating ambient temperature and the reference temperature, a step S142 of determining a compensation value for eliminating the influence of the temperature difference on the characteristic value, and a step S143 of applying the compensation value to the characteristic value.

In this example embodiment, the compensation value corresponding to the temperature variation may be determined based on the temperature variation, and the compensation value may be applied to the characteristic value to complete the temperature compensation processing of the characteristic value.

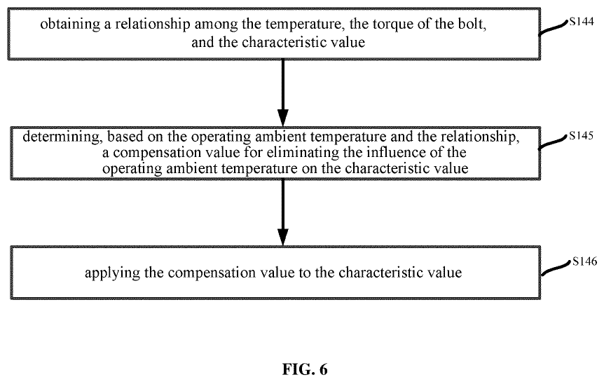

In one possible example of a method, as shown in FIG. 6, the step S140 may include a step S144 of obtaining a relationship among the temperature, the torque of the bolt, and the characteristic value, a step S145 of determining, based on the operating ambient temperature and the relationship, a compensation value for eliminating the influence of the operating ambient temperature on the characteristic value, and a step S146 of applying the compensation value to the characteristic value.

In this example embodiment, a correspondence relationship among the torque, the temperature, and the characteristic value may be stored. A characteristic value influenced by the temperature may be determined based on the correspondence relationship, a compensation value may be determined based on the found characteristic value, and the compensation value may be applied to the characteristic value to complete the temperature compensation processing of the characteristic value.

FIG. 13 is a block diagram of a system for detecting bolt loosening according to an example embodiment of the present invention. As shown in FIG. 13, the detection system 1400 includes a function generator 1410 to generate an excitation signal, a piezoelectric sensor 1420 provided on a bolted connection structure, the piezoelectric sensor 1420 being connected to the function generator 1410 and using the excitation signal as an input signal, and a processor 1430 connected to the piezoelectric sensor 1420 and to, based on a signal delivered through a bolt detected by the piezoelectric sensor 1420, calculate a characteristic value of the signal delivered through the bolt, to perform temperature compensation processing on the characteristic value based on an operating ambient temperature of the bolt, and to detect whether the bolt loosens based on the characteristic value on which the temperature compensation processing has been performed, wherein the temperature compensation processing is to eliminate an influence of the operating ambient temperature on the characteristic value.

In one possible example, the detection system 1400 may further include a power amplifier (not shown), an input terminal and an output terminal of which are connected to an output terminal of the function generator and an input terminal of the piezoelectric sensor, respectively, to amplify the excitation signal.

In one possible example, the piezoelectric sensor 1420 may include a first piezoelectric sensor and a second piezoelectric sensor (not shown) provided on a first plate of the bolted connection structure to receive the excitation signal, and a third piezoelectric sensor (not shown) provided on a second plate of the bolted connection structure to detect the signal delivered through the bolt.

In one possible example, the piezoelectric sensor 1420 may include a first piezoelectric sensor and a second piezoelectric sensor (not shown) provided on a first plate of the bolted connection structure to receive an amplified excitation signal, and a third piezoelectric sensor (not shown) provided on a second plate of the bolted connection structure to detect the signal delivered through the bolt.

In some example embodiments, the functions of or the modules included in the devices provided by the example embodiments of the present invention may be used to perform the methods described in the above method example embodiments, the specific implementation of which may refer to the description of the above method example embodiments and will not be repeated herein for the sake of brevity.

The flowcharts and block diagrams in the drawings illustrate the architecture, function, and operation that may be provided by the system, method and computer program product according to the various example embodiments of the present invention. In this regard, each block in the flowchart or block diagram may represent a portion of a module, a program segment, or a portion of code, which includes one or more executable instructions to provide the specified logical function(s). In some alternative implementations, the functions denoted in the blocks may occur in an order different from that denoted in the drawings. For example, two contiguous blocks may be executed substantially concurrently, or sometimes they may be executed in a reverse order, depending upon the functions involved. It will also be noted that each block in the block diagram and/or flowchart, and combinations of blocks in the block diagram and/or flowchart, can be provided by dedicated hardware-based systems performing the specified functions or acts, or by combinations of dedicated hardware and computer instructions.

Although the example embodiments of the present invention have been described above, it will be appreciated that the above descriptions are merely exemplary, and are not exhaustive. The disclosed example embodiments are not limiting. A number of variations and modifications may be provided by one skilled in the art without departing from the scope and spirit of the described example embodiments. The terms in the present disclosure are selected to provide the best explanation of the principles and practical applications of the example embodiments and the technical improvements to the arts on the market, or to make the example embodiments described herein understandable to one skilled in the art.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A method for detecting bolt loosening, the method comprising:
applying an excitation signal to a piezoelectric sensor on a bolted connection structure;
detecting a signal delivered through a bolt;
calculating, from a detected signal, a characteristic value of the signal delivered through the bolt;
performing temperature compensation processing on the characteristic value based on an operating ambient temperature of the bolt; and
detecting whether the bolt loosens based on the characteristic value on which the temperature compensation processing has been performed.

2. The method according to claim 1, wherein
the performing the temperature compensation processing on the characteristic value based on the operating ambient temperature of the bolt includes:
calculating a temperature difference between the operating ambient temperature and a reference temperature;
determining a compensation value to eliminate an influence of the temperature difference on the characteristic value; and
applying the compensation value to the characteristic value.

3. The method according to claim 1, wherein
the performing the temperature compensation processing on the characteristic value based on the operating ambient temperature of the bolt includes:
obtaining a relationship among the temperature, a torque of the bolt, and the characteristic value;
determining, based on the operating ambient temperature and the relationship, a compensation value to eliminate the influence of the operating ambient temperature on the characteristic value; and
applying the compensation value to the characteristic value.

4. The method according to claim 1, wherein
the calculating, from the detected signal, the characteristic value of the signal delivered through the bolt includes:
performing a frequency domain transformation on the detected signal to convert a voltage signal in a time domain into a voltage signal in a frequency domain; and
calculating transmitted energy to detect bolt loosening based on the voltage signal in the frequency domain, the transmitted energy representing energy generated by the signal delivered through the bolt; wherein
the characteristic value includes the transmitted energy.

5. The method according to claim 4, wherein the larger a contact area between the bolt and the bolted connection structure, the greater the transmitted energy.

6. The method according to claim 1, wherein
the calculating, from the detected signal, the characteristic value of the signal delivered through the bolt includes:
obtaining a sideband response of the detected signal; and
calculating a nonlinear index for detecting bolt loosening based on the sideband response and an amplitude of a frequency of the excitation signal; wherein
the characteristic value includes the nonlinear index.

7. The method according to claim 1, wherein the temperature compensation processing is to eliminate an influence of the operating ambient temperature on the characteristic value.

8. A system for detecting bolt loosening, the system comprising:
a function generator to generate an excitation signal;
a piezoelectric sensor on a bolted connection structure, the piezoelectric sensor being connected to the function generator and including the excitation signal as an input signal; and
a processor connected to the piezoelectric sensor and calculate, based on a signal delivered through a bolt detected by the piezoelectric sensor, a characteristic value of the signal delivered through the bolt, to perform temperature compensation processing on the characteristic value based on an operating ambient temperature of the bolt, and to detect whether the bolt loosens based on the characteristic value on which the temperature compensation processing has been performed.

9. The system according to claim 8, further comprising:
a power amplifier, an input terminal, and an output terminal connected to an output terminal of the function generator and an input terminal of the piezoelectric sensor, respectively, to amplify the excitation signal.

10. The system according to claim 8, wherein the piezoelectric sensor includes:
a first piezoelectric sensor and a second piezoelectric sensor on a first plate of the bolted connection structure to receive the excitation signal; and
a third piezoelectric sensor on a second plate of the bolted connection structure to detect the signal delivered through the bolt.

11. The system according to claim 9, wherein the piezoelectric sensor includes:
a first piezoelectric sensor and a second piezoelectric sensor on a first plate of the bolted connection structure to receive an amplified excitation signal; and
a third piezoelectric sensor on a second plate of the bolted connection structure to detect the signal delivered through the bolt.

12. The system according to claim 8, wherein the piezoelectric sensor is a piezoelectric wafter active sensor.

13. The system according to claim 8, wherein the temperature compensation processing is to eliminate an influence of the operating ambient temperature on the characteristic value.
